(19) United States
(12) Patent Application Publication
(10) Pub. No.: US 2012/0008135 A1
(43) Pub. Date: Jan. 12, 2012

(54) FLUORESCENCE-DETECTING DISK INSPECTION SYSTEM

(76) Inventors: Gregory Toker, Jerusalem (IL); Andrei Brunfeld, Cupertino, CA (US); Bryan Clark, Mountain View, CA (US)

(21) Appl. No.: 13/179,517

(22) Filed: Jul. 9, 2011

Related U.S. Application Data
(60) Provisional application No. 61/363,422, filed on Jul. 12, 2010.

(51) Int. Cl. G01N 21/17; G01N 21/64; G01N 21/47

(52) U.S. Cl. 356/73

(57) ABSTRACT

An optical inspection system includes a fluorescence channel that detects fluorescent behavior (or lack thereof) of artifacts present on a surface under inspection and at least one other optical channel for determining a characteristic of the surface under inspection in an illuminated spot. The other optical channel may be a height measuring channel, such as an interferometric channel or a deflectometric channel, the other optical channel may be a scatterometric channel, or both height measurement and scatterometry may be employed in combination as a three channel system. The presence of absence of fluorescent behavior may be used to correct assumptions about or determine a type of artifact detected by scatterometry, and may be used to correct the polarity of a height measurement made by a height-measuring channel.

The present U.S. patent application claims priority to U.S. Provisional Patent Application Ser. No. 61/363,422 filed on Jul. 12, 2010.

### BACKGROUND OF THE INVENTION

1. Field of the Invention

This invention relates to optical inspection and inspection systems, and more specifically, to an optical inspection head and system in which a fluorescence-detecting channel is combined with another optical inspection channel.

2. Background of the Invention

During optical surface inspection, it is often desirable to determine if a defect is part of the surface (i.e., material protruding from the surface or a portion of the surface that is inset), or whether the defect is foreign material on the surface. Therefore, it is also often desirable to determine or at least distinguish, the material forming the defect.

Current optical inspection techniques such as scatterometry can locate a defect, but cannot not identify the material forming of defect or distinguish whether the defect is inset or protruding. Further, if interferometry is used to measure the surface under inspection, transparent or opaque contaminants may affect the optical height of the surface at the location of the defect, in some cases leading to a determination that material deposited on the surface under inspection is an inset and vice-versa.

Therefore, it would be desirable to provide an optical inspection system, optical inspection head, and methods of operation of an optical inspection system that provide further information about material composition of artifacts present on or in a surface under inspection.

### SUMMARY OF THE INVENTION

The foregoing objectives are achieved in an optical inspection system and a method of operation of the optical inspection system. The optical inspection system includes a fluorescence channel that detects fluorescent behavior (or lack thereof) of artifacts present on a surface under inspection and at least one other optical channel for determining a characteristic of the surface under inspection in an illuminated spot.

The other optical channel may be a height measuring channel, such as an interferometric channel or a deflectometric channel, the other optical channel may be a scatterometric channel, or both height measurement and scatterometry may be employed in combination as a three channel system.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIGS. 1A and 1B are pictorial diagrams illustrating an ambiguity in the height of a feature disposed on or in a surface under inspection.

FIGS. 2A and 2B are pictorial diagrams illustrating an ambiguity in the inclination of a feature disposed on or in a surface under inspection.

FIG. 3 is a block diagram depicting an optical inspection system in accordance with an embodiment of the present invention.

FIG. 4 is an optical schematic diagram depicting an optical inspection system in accordance with an embodiment of the present invention.

### DESCRIPTION OF ILLUSTRATIVE EMBODIMENT

The present invention encompasses optical inspection systems in which combine one or more measurement/detection optical channels, such as a scatterometer, an interferometer or a deflectometer, with a fluorimetry channel. The result is that the optical inspection system can differentiate organic materials that exhibit fluorescent behavior, from other particulate or features of a surface under inspection. During optical surface inspection, it is often desirable to determine if a defect is part of the surface (i.e., material protruding from the surface or a portion of the surface that is inset), or whether the defect is foreign material on the surface. Therefore, it is also often desirable to determine or at least distinguish, the material forming the defect. Current techniques such as scatterometry can locate a defect, but cannot not identify the material forming of defect or distinguish whether the defect is inset or protruding. Further, if interferometry is used to measure the surface under inspection, transparent or opaque contaminants may affect the optical height of the surface at the location of the defect, in some cases leading to a determination that material deposited on the surface under inspection is an inset and vice-versa. Further, when dark-field detection is employed in one or more of the optical channels, it is desirable to separate the scattering detection from the surface noise induced by illumination.

Embodiments of the present invention provide techniques for accurately measuring the size and/or height of defects on the surface of, or within an article under inspection. In particular, certain embodiments of the present invention provide techniques for measuring the height of a surface in the presence of artifacts such as transparent defects on the surface of a media or other article being inspected or detecting differences in material of an object located by scattering detection. Transparent defects as described herein are distinguished from pits, since pits are caused by the absence of material, rather than the presence of additional material. In scattering measurements, the difference between a bump (i.e., a raised region of the ordinary surface material) and a piece foreign matter may be determined by fluorescence detection. As noted above, interferometric and deflectometric height measurement systems generate erroneous results for transparent defects, since the optical path through the defect will differ from optical path through air (or the inspection environment) due a higher index of refraction within the defect. The present invention provides additional information for correcting the results by determining whether a transparent organic material is present, which in most cases can be assumed to be a deposit (positive height artifact), but in some cases may be a recess, for example when a metal coating on an organic substrate is pitted.

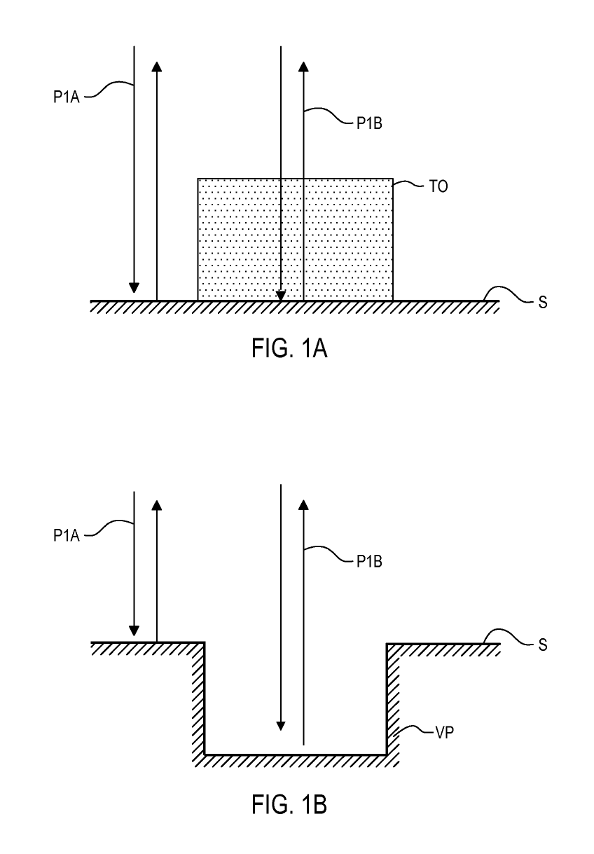

Referring now to FIGS. 1A-1B, a source of error in an interferometry inspection of a surface S is illustrated. As illustrated in FIG. 1A, when a transparent object TO is present on surface S, the reference optical inspection path P1B is optically longer than a similar optical path P1A through air, due to the higher refractive index of transparent object TO. Therefore, optical path P1B will measure as longer. When a model of optical measurements in an interferometry inspection is a surface height model, then the measurement illustrated in FIG. 1A yields a result illustrated in FIG. 1B. The longer optical path P1B indicates the presence of a pit defect, or lowered surface height, which is illustrated as “virtual pit” VP. However, indication of the presence of virtual pit VP is an erroneous result, as there is no actual pit, but rather a transparent deposit TO on surface S, as the illustration of FIG. 1A represents the actual condition of surface S in the example of FIGS. 1A and 1B. In other examples, the illustration of FIG. 1B may represent an actual pit that is treated as a transparent defect in a system that treated all longer interferometric paths as transparent surface defects. Therefore, it would be desirable to distinguish between the two possibilities illustrated above for the underlying cause of the longer optical path P1B to and from surface S.

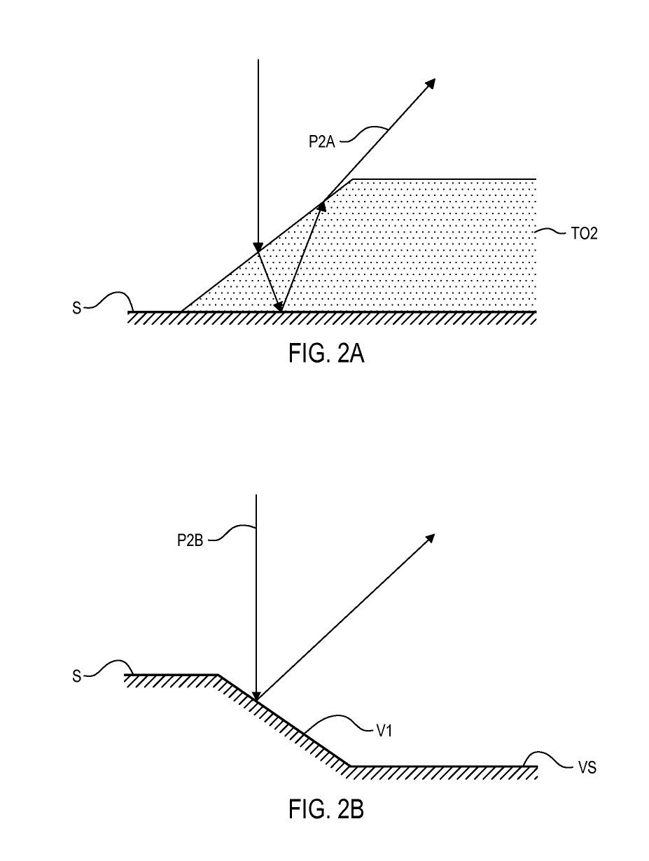

Referring now to FIGS. 2A-2B, a similar error in a deflectometric (specular reflection) measurement system is illustrated that also yields an erroneous result when a transparent object TO2 is present on surface S. In the illustration of FIG. 2A, as the inclined side of transparent object TO2 is encountered, illumination passing along optical path P2A is refracted by entry into transparent object TO2, reflected by surface S and then refracted again by at the exit transition from the top surface of transparent object TO2 back into air. The resulting specular reflection has a directional change that resembles reflecting from an inclined edge of surface S, represented by virtual incline VI illustrated in FIG. 2B. The direction of light reflected (and then detected by a deflectometer) along optical path P2A is identical to that of light reflected along optical path P2B in FIG. 2B and therefore the two conditions (inclined edge VI in FIG. 2B and the edge of transparent object TO2 in FIG. 2A) are indistinguishable by the illustrated deflectometric techniques. Therefore, it would be desirable to resolve the ambiguity presented by the deflectometric measurement described above.

The interferometric or deflectometric height measuring channel in a system according to the present invention, is supplemented by a fluorescence detecting channel, which provides resolution of the above-described ambiguities for most, if not all, transparent surface deposits that may be present on a surface under inspection. Since most transparent deposits are organic in nature, those deposits have fluorescence characteristics. One embodiment of the detection system of the present invention has two parallel synchronous detection channels, one for height-measuring inspection (interferometric or deflectometric) and one for detection of fluorescence. A “DOWN” defect diagnosed as having a negative height below a nominal height, as detected by a height measuring channel, but that also causes a simultaneous fluorescence signal, can be reported as transparent “UP” defect having positive height, since the negative height measurement from the height measuring channel is due to the index of refraction of the defect.

Inspection logic according to the present invention can therefore be implemented as illustrated in the following table:

TABLE I

| Height Measurement | Fluorescence | Defect Type |
|---|---|---|
| UP | YES | non-transparent |
| | | organic deposit (UP) |
| UP | NO | UP defect |
| DOWN | YES | transparent organic |
| | | deposit (UP) |
| DOWN | NO | DOWN defect |
| NONE | YES | organic deposit (UP) |

The inspection logic presented above is a simple example of a use of additional information provided by the fluorescence channel in conjunction with the information provided from a height-measuring channels such as the interferometers or deflectometer channels mentioned above. More sophisticated logic can be employed, making full use of particular properties of the height measurement and additional scattering measurement channels, when a scatterometer is included with the height measuring channel (interferometer or deflectometer) and the fluorescence detecting channel.
Interferometer/scatterometer combinations are described in U.S. Pat. No. 7,671,978, by the same inventors and assigned to the same Assignee, the disclosure of which is incorporated herein by reference.

In optical systems according to embodiments of the present invention, the fluorescence channel can detect fluorescence generated in response to the same laser beam as employed for the height measuring channel, which generally can be done if the laser is of a sufficiently short wavelength. However, it is possible to use a second laser focused on the surface at a fixed known offset from the height measuring beam and having appropriate wavelengths selected according to the types of material that are being detected. Also, since many substrates generate some amount of fluorescence from the illumination beam used to illuminate for scattering detection and/or height measurement, the fluorescence will introduce a background noise. Therefore, separating the fluorescence and scattering signals by wavelength will improve the signal-to-noise of both channels.

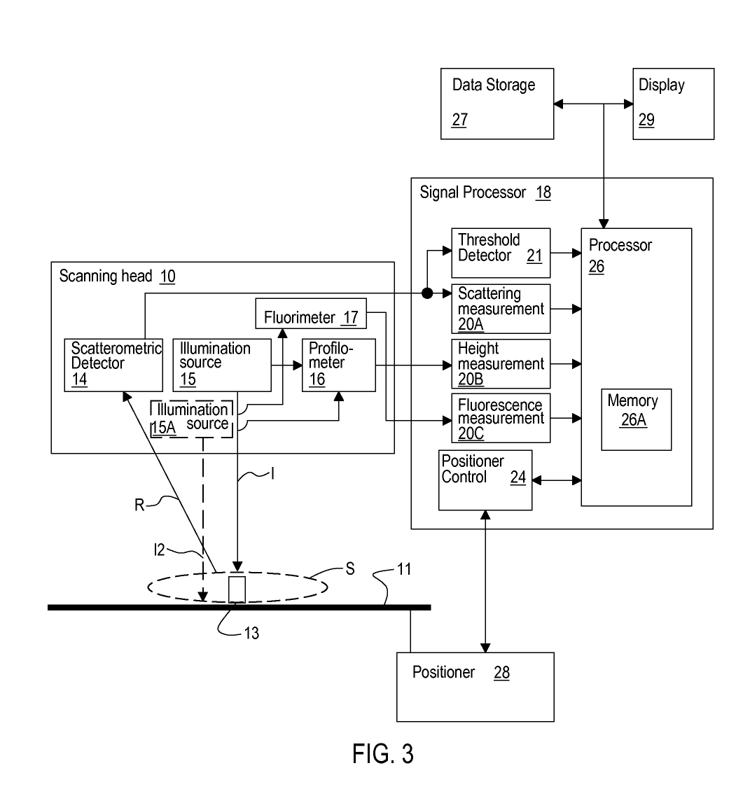

Referring now to FIG. 3, an optical inspection system in which an embodiment of the present invention is practiced, is shown. A scanning head 10 is positioned over a surface under inspection 11, which is moved via a positioner 28 that is coupled to a signal processor 18. From scanning head 10, illumination I of surface under inspection 11 is provided by an illumination source 15 to generate an illuminated spot S. A scatterometric detector 14 receives light scattered from surface under inspection 11 along optical path R from illumination spot S generated by illumination I. Scatterometric optical path R gathers light from one or more non-specular angles with respect to illumination I and surface under inspection 11, so that light scattered from an artifact 13 (which may be a surface defect or feature, or an extraneous particle) disposed on (or in) surface under inspection 11, indicates the presence of the artifact. A profilometer 16 is included, such as an interferometer channel that interferes reflected light R returning along the illumination path, or another optical path and combines the reflected light R with light directly coupled from illumination source 15 to determine the height of surface under inspection 11 within illumination spot S. In accordance with another embodiment of the invention, instead of an interferometric channel, a deflectometric channel can be provided as profilometer channel 16 and used to measure surface height variations, which are then integrated to obtain a profile of the surface height. Optical inspection systems in accordance with embodiments of the present invention include a fluorimeter channel 17 that detect fluorescent behavior of artifact 13 that is generated either in response to illumination I or an optional secondary illumination 12 provided from another illumination source 15A.

While the illustration shows a positioner 28 for moving surface under inspection under scanning head 10, it is understood that scanning head 10 can be moved over a fixed surface, or that multiple positioners may be employed, so that both scanning head 10 and surface under inspection 11 may be moved in the measurement process. Further, while scattering detector 14 and illumination source 15 are shown as included within scanning head 10, optical fibers and other optical pathways may be provided for locating scattering detector 14 and illumination source(s) 15 physically apart from scanning head 10.

Signal processor 18 includes a processor 26 that includes a memory 26A for storing program instructions and data. The program instructions include program instructions for controlling positioner 28 via a positioner control circuit 24, and performing measurements in accordance with the output of scatterometric detector 14 via scatterometer measurement circuit 20A that include signal processing and analog-to-digital conversion elements as needed for receiving the output of scatterometric detector 14 and providing an output to processor 26. Fluorimeter channel 17 is coupled to a fluorescence measurement circuit 20C that provides another output to processor 26. Profilometer channel 16 is coupled to a height measurement circuit 20B that also provides an output to processor 26. A dedicated threshold detector 21 can be employed to indicate to processor 26 when scattering from an artifact 13 on surface under measurement 11 has been detected above a threshold. As an alternative, continuous data collection may be employed. Processor 26 is also coupled to an external storage 27 for storing measurement data and a display device 29 for displaying measurement results, by a bus or network connection. External storage 27 and display device 29 may be included in an external workstation computer or network connected to the optical inspection system of the present invention by a wired or wireless connection.

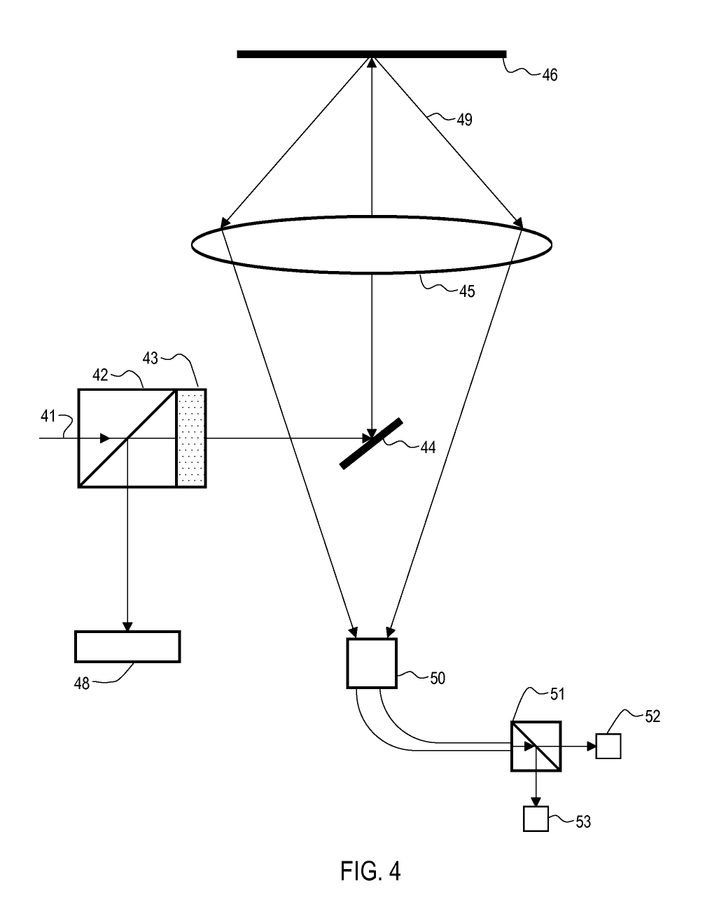

Referring now to FIG. 4, an optical system in accordance with another embodiment of the present invention is shown, which may be implemented in the optical inspection system of FIG. 3. In the depicted embodiment, three detection channels are present: 1) a bright-field height measuring channel (deflectometric or interferometric), 2) a dark-field scattering channel, and 3) a fluorescence detection channel obtained by chromatically splitting the light collected in the scattering channel, since fluorescence occurs at a longer wavelength than that of the illumination (excitation) wavelength. Since the fluorescence emission has an angular spectrum similar to that of the scattering angular spectrum, both can be collected within the same dark-field channel and sent to appropriate detection sub-channels.

An illumination beam 41 is focused to provide an illumination spot on surface under inspection 46. Illumination beam 41 is directed to surface under inspection 46 by bending mirror 44. Light returning along the illumination path is split by polarizing beam splitter 42 that includes a quarter-wave plate 3 to form an optical isolator. Light scattered from, and fluorescent emissions from, surface under inspection 46, is collected by a collecting lens 45, which directs the collected light to a fiber collector 50. Fiber collector 50 directs the collected light to a chromatic beamsplitter 51 that directs the collected scattered illumination (of shorter wavelength) to a scattering detector 53 and collected fluorescent emissions into a second fluorescence detector 52. The embodiment of the invention depicted in FIG. 4 may be implemented in a very compact and light-weight optical head. However, other collection and chromatic splitting configurations can also be used to provide the fluorescence channel. For example, lens 45 can be used to collimate the collected scattered light and a prism, by including an appropriate dichroic coating, a diffraction grating, or any other chromatic splitter device known in art can be used to separate the fluorescence channel from the scattering one.

In the embodiment of the invention depicted in FIG. 4, the same laser source 41 is used for scattering detection and fluorescence stimulation. If desired, and as illustrated in the system of FIG. 3 a separate laser, preferably focused into the same illumination spot surface under inspection 46, can also be used for exciting fluorescence in surface features/artifacts. The above-described alternative configuration may be advantageous if a shorter wavelength, such as near-UV, is needed to excite fluorescence in a given particular type of organic contamination.

Embodiments of the optical system of the present invention provide a method of identification of organic deposits, both transparent and non-transparent for correct discrimination of up/down artifacts and therefore provides, in some environments, the ability to distinguish between cleanable defects and those that result in permanent rejection of articles being tested such as optical or magnetic media. Embodiments of the present invention also provide a very compact configuration that can include height measuring channels and/or scattering defect detection, along with fluorescence detection in order to distinguish the type of defect. Therefore, the system of the present invention can prevent confusion of organic contamination with pits in a surface under inspection. The results of the fluorescence detection can also be used to resolve confusion between organic contamination or surface features and other non-organic surface artifacts or features, providing a better diagnostic for surface cleaning. The results of height measurements may be corrected by processor 26 of FIG. 3 according to Table I above.

The present invention may also be applied in wafer inspection and other polished surface inspection and also in transparent feature/object inspection, using a detection layer that differs from the nominal (reference) surface.

Application of the techniques of the present invention may also be applied to reduce the background noise of the scattering channel by separating the scattering-only detection from the fluorescence induced into the substrate by the illumination beam. The illumination-induced substrate fluorescence has a spatial distribution similar to the scattering and will superimpose onto a dark-field signal as an undesirable background. Separating the two signals, scattering and fluorescence, will improve the signal-to-noise ratio of the scattering channel.

While the above-described exemplary optical inspection system includes a fluorescence channel in addition to a scattering channel and an interferometric or deflectometric channel in accordance with an embodiment of the invention, other systems in accordance with other embodiments of the invention include systems having only a scattering channel and a fluorescence channel and systems having an interferometric or deflectometric channel in conjunction with a fluorescence channel.

While the invention has been particularly shown and described with reference to the preferred embodiments thereof, it will be understood by those skilled in the art that the foregoing and other changes in form and details may be made therein without departing from the spirit and scope of the invention.

What is claimed is:

1. An optical inspection system, comprising:
an illumination subsystem for providing an illumination spot on a surface under inspection;
a first optical channel for determining a first characteristic of the surface under inspection by measuring light returning from the illumination spot; and
a second fluorescence-detecting channel for detecting fluorescent behavior of an artifact disposed on the surface under inspection.

2. The optical inspection system of claim 1, wherein the first optical channel is a height-measuring channel for providing an indication of a height of the surface under inspection in the illumination spot.

3. The optical inspection system of claim 1, further comprising a scatterometer for detecting artifacts disposed in the area of the surface under inspection illuminated by the illumination spot from light scattered from the surface under inspection.

4. The optical inspection system of claim 2, wherein the first optical channel is an interferometer for providing an indication of a height of the surface under inspection in the illumination spot.

5. The optical inspection system of claim 2, wherein the first optical channel is a deflectometer for providing an indication of a height of the surface under inspection in the illumination spot.

6. The optical inspection system of claim 1, wherein the first optical channel is a scatterometer for detecting artifacts disposed in the area of the surface under inspection illuminated by the illumination spot.

7. The optical inspection system of claim 1, further comprising a processing subsystem having inputs coupled to outputs of the first optical-measuring channel and the fluorescence detecting channel for determining whether the artifact is an organic contaminant in conformity with whether or not the fluorescence detecting channel detects that the artifact has fluorescent behavior.

8. The optical inspection system of claim 7, wherein the first optical channel is a height-measuring channel for providing an indication of a height of the surface under inspection over the area of the surface under inspection illuminated by the illumination spot, and wherein the processing subsystem corrects the indication of the height of the surface under inspection in conformity with a result of the determining whether or not the artifact is an organic contaminant.

9. The optical inspection system of claim 1, wherein the second fluorescence-detecting channel detects fluorescent behavior generated in response to illumination from the illumination subsystem.

10. The optical inspection system of claim 1, wherein the illumination subsystem is a first illumination subsystem, and wherein the optical inspection system further comprises a second illumination system having a wavelength differing from a wavelength of the first illumination subsystem, and wherein the second fluorescence-detecting channel detects fluorescent behavior generated in response to illumination from the second illumination system.

11. A method of optical inspection, comprising:
illuminating a spot on a surface under inspection;
determining a first characteristic of the surface under inspection by measuring light returning from the illuminated spot; and
detecting fluorescent behavior of an artifact disposed on the surface under inspection.

12. The method of claim 11, wherein the determining measures a height of the surface of under inspection over the area of illuminated spot.

13. The method of claim 12, further comprising detecting artifacts disposed in the area of the surface under inspection illuminated by the illumination spot by detecting light scattered from the surface under inspection in the area of the illuminated spot.

14. The method of claim 12, wherein the determining comprises performing an interferometric measurement of light returning from the illuminated spot.

15. The method of claim 12, wherein the determining first optical measuring channel measures a deflection of light returning from the illumination spot to provide an indication of a height of the surface under inspection over the area of the illuminated spot.

16. The method of claim 11, wherein the determining comprises detecting artifacts disposed in the area of the surface under inspection illuminated by the illumination spot by detecting light scattered from the surface under inspection in the area of the illuminated spot.

17. The method of claim 11, further comprising determining whether the artifact is an organic contaminant in conformity with whether or not the detecting detects that the artifact has fluorescent behavior.

18. The method of claim 17, wherein the first optical measuring channel is a height-measuring channel for providing an indication of a height of the surface under inspection over the area of the surface under inspection illuminated by the illumination spot, and wherein the processing subsystem corrects the indication of the height of the surface under inspection in conformity with a result of the determining whether or not the artifact is an organic contaminant.

19. The method of claim 11, wherein the detecting detects fluorescent behavior generated in response to the illuminating.

20. The method of claim 11, wherein the illuminating comprises first illuminating the surface under inspection with a first wavelength, and wherein the method further comprises further comprising second illuminating the surface under inspection with a second wavelength differing from the first wavelength and wherein the detecting detects fluorescent behavior generated in response to the second illuminating.

21. An optical inspection head, comprising:
a first optical channel for determining a first characteristic of the surface under inspection by measuring light returning from a surface under inspection; and
a second fluorescence-detecting channel for detecting fluorescent behavior of an artifact disposed on the surface under inspection.

22. The optical inspection head of claim 21, wherein the first optical channel is an interferometric channel.

23. The optical inspection head of claim 22, further comprising a third scatterometric channel for detecting light scattered from the surface under inspection.

24. The optical inspection head of claim 21, wherein the first optical channel is a deflectometric channel.

25. The optical inspection head of claim 21, wherein the first optical channel is a scatterometric channel.
